(19) United States
(12) Patent Application Publication
(10) Pub. No.: US 2005/0190877 A1
(43) Pub. Date: Sep. 1, 2005

(54) Method for repairing or preventing damage to a bushing

(75) Inventor: Manfred Knapp, Erlangen (DE)

Correspondence Address: LERNER AND GREENBERG, PA, P O BOX 2480, HOLLYWOOD, FL, 33022-2480, US

(73) Assignee: Framatome ANP GmbH

(21) Appl. No.: 11/108,434

(22) Filed: Apr. 18, 2005

Related U.S. Application Data
(63) Continuation of application No. PCT/EP03/11339, filed on Oct. 14, 2003.

(30) Foreign Application Priority Data
Oct. 17, 2002 (DE) 102 48 427.9

(51) Int. Cl. G21C 13/00

(52) U.S. Cl. 376/203

(57) ABSTRACT

A method for repairing or preventing damage to a bushing welded into a container of the coolant circuit of a water-cooled nuclear reactor by an inner welding seam, especially damage to an instrumentation pipe guided through the wall of a reactor pressure reservoir of a pressurized water reactor. The damage being caused in a hazardous area, especially in the region of the welding seam, by the action of the water inside the bushing or inside the container, on the surface thereof which is in contact with the water. At least one of the surfaces is protected against the action of the water by a cover) which is mechanically fixed to the bushing and therefore not in the form of a weld connection.

### CROSS-REFERENCE TO RELATED APPLICATION

This is a continuing application, under 35 U.S.C. § 120, of copending international application No. PCT/EP2003/011339, filed Oct. 14, 2003, which designated the United States; this application also claims the priority, under 35 U.S.C. § 119, of German patent application No. 102 48 427.9, filed Oct. 17, 2002; the prior applications are herewith incorporated by reference in their entirety.

### BACKGROUND OF THE INVENTION

### Field of the Invention

The invention relates to a method for repairing or preventing damage to a bushing, which is welded into a vessel for the coolant circuit of a water-cooled nuclear reactor by an internal weld bead, in particular to an instrumentation tube which is passed through the wall of a reactor pressure vessel of a pressurized water reactor.

The reactor pressure vessels of pressurized water reactors are frequently provided with bushings on their lower cup, through which bushings core instrumentation probes are inserted from the outside into the reactor pressure vessel. The bushings or instrumentation tubes (LCIP=Lower Core Instrumentation Penetration) are produced from a forged rod with a hole through it, and are welded in by a weld bead located within the reactor pressure vessel. Particularly in older systems, the bushings and the weld filler use materials, which have been found to be particularly susceptible to stress corrosion cracking. In this case, stress corrosion cracking is a corrosion process, which occurs in the vicinity of water on components that have internal stresses.

FIG. 5 shows a typical damage illustration, as has already been observed, on quite a number of occasions throughout the world. FIG. 5 shows a section through a wall 2 of a reactor pressure vessel 4 in the area of a bushing 6 such as this. The bushing 6 is provided with a bushing opening 8 through which non-illustrated instrumentation probes are inserted into the reactor pressure vessel 4. In the area of the bushing 6, the wall 2 is provided with a buffer weld 9a composed of Inconel on the inside. Some pressure vessels are also provided with a buffer weld 9b such as this on the outside, although this has no function in the original state. The bushing 6 is welded into the wall 2 by an internal weld bead 10, likewise composed of Inconel, over the internal buffer weld 9a.

At its end which projects out of the reactor pressure vessel 4, the pressure-tight casing tube of the core instrumentation is connected to the bushing 6, and the reactor pressure vessel 4 and the bushing opening 8 are filled with water during reactor operation.

FIG. 5 shows a typical illustration of damage with crack faults 12a, 12b, as occur in the weld bead 10 and in the buffer weld 9b in a area 13 which is at risk of stress corrosion cracking and is surrounded by dashed lines in FIG. 5, that is to say in the vicinity of the weld bead 10, by the influence of the water originating from the inner surface of the bushing 6 (crack fault 12a) in the wall of the bushing 6, or originating from that surface of the area 13 (crack fault 12b) in the wall 2 of the reactor pressure vessel 4 which faces the interior of the reactor pressure vessel 4.

Published, European patent application EP 0 608 806 A1 discloses a method for repairing a connecting stub which passes through the base of a reactor pressure vessel, in which the damaged connecting stub is cut off above the inner face of the base, forming a seal. A new connecting stub part is inserted into the remaining part, and is welded to the remaining part. In this case, the inserted connecting stub part covers the internal surface of the bushing in the area of the reactor pressure vessel base. The welded joints also ensure that no water can enter the gap between the original connecting stub part and the new connecting stub part. This makes it possible to stop any stress corrosion cracking which may have already started in the original connecting stub part. However, these known repair methods involve complex welding tasks in the area of the connecting stub.

### SUMMARY OF THE INVENTION

It is accordingly an object of the invention to provide a method for repairing or preventing damage to a bushing which overcomes the above-mentioned disadvantages of the prior art methods this general type, which can be carried out easily and without complex welding work on the bushing, and which allows it to be permanently repaired.

The method repairs or prevents damage to a bushing, which is welded into a vessel for the coolant circuit of a water-cooled nuclear reactor by an internal weld bead, in particular to an instrumentation tube which is passed through the wall of a reactor pressure vessel of a pressurized water reactor, which damage is caused in an endangered area, in particular in the area of the weld bead, by the influence of water, which is located within the bushing or within the vessel on its surface that is in contact with the water. At least one of the surfaces is protected against the influence of water by a cover that is mechanically connected to the bushing.

For the purposes of the present invention, mechanically connected to the bushing means that the cover is connected to the bushing either in an interlocking manner or with a force fit, but not with an integral joint in the form of a welding joint.

The fitting of a cover which is mechanically connected to the bushing means that only mechanical processing methods are required on the bushing or on the inner wall of the vessel, so that the required work can be carried out either underwater (when the method is carried out in the interior of the reactor pressure vessel) or from outside the reactor pressure vessel (when working on the inner surface of the bushing) without any problems without any need to empty the reactor pressure vessel. Before carrying out work from outside the reactor pressure vessel, the bushing is provided with a sealing cap on the inside and the casing tube connected on the outside is cut off. Since, furthermore, no welding work is carried out on the bushing (which would itself cause additional stresses in the bushing that is susceptible to damage and/or in the wall area of the vessel that is susceptible to damage), it can be repaired permanently.

Particularly in the case of damage with the illustrated damage, which has occurred or can be expected within the bushing itself, the cover is preferably provided by the inner surface of the bushing.

In one advantageous refinement of the method the internal cross-section area of the bushing is first enlarged to a depth which is greater than the depth of the endangered area, by a mechanical machining method, in particular by drilling or milling, and an internal sleeve is then inserted as a cover. This allows the cover to be introduced from outside the vessel, so that there is no need to empty it after sealing the bushing from the inside. The internal sleeve is preferably of such a size that its internal dimensions match the internal dimensions of the unmachined bushing.

In a further refinement of the method, the bushing is provided with an internal thread into which the internal sleeve is screwed. This allows the internal sleeve to be mechanically axially fixed particularly easily.

In particular, the bushing is provided at the bottom of the enlarged internal area with a shoulder which is circumferential on the internal circumference and on which the end surface of the internal sleeve is seated, forming a seal. Therefore water cannot enter the unavoidable gap between the internal sleeve and the bushing, thus preventing a crack propagation or crack formation.

A sealing ring is preferably inserted between the shoulder and the end surface. This results in a good sealing effect in a particularly simple manner.

In a further advantageous refinement, a part of the bushing which faces away from the internal face of the vessel is cut off and an internal sleeve is inserted, which projects beyond the remaining part of the bushing, with the projection substantially being in the same shape as the part which has been cut off, in order to allow the casing tube to be connected as in the original state.

In particular, a part of the bushing which faces away from the internal face of the vessel is cut off, which part is longer than that part of the bushing which projects into the space outside the vessel, in such a way that the resultant cut surface is located within the wall of the vessel. An outer sleeve, which is used to guide the internal sleeve, is introduced into the wall as far as the cut surface and is welded on the vessel wall to the outside, over the buffer weld. This measure results in that the possibility of the bushing cracking off completely presents no problems.

Particularly in the case of damage as from the damage illustration, which is located in the weld bead, that surface which is located within the vessel is covered. In one preferred refinement of the method, a cap which is mounted on the outer surface of the bushing is pushed on to that part of the bushing which projects into the vessel, and forms a seal, and its lower rim rests on the surface of the vessel forming a seal, and thus surrounds the endangered area.

In a further advantageous procedure, the bushing is provided with an external thread at its free end which projects into the vessel, onto which external thread a retaining nut is screwed in order to exert a compression force on the cap. This allows a good push fit to be achieved between the cap and the inner wall of the vessel in a particularly simple manner, that is to say with a minimum amount of machining effort on the bushing.

A cap is preferably used whose upper rim is provided on its inner rim with an incline such that a depression is formed between the bushing and the upper rim of the cap, into which a sealing ring is inserted, which is pressed both against the outer surface of the bushing and against the incline while the retaining nut exerts a compression force, preventing the ingress of water between the bushing and the cap.

A particularly good sealing effect is achieved between the inner surface of the vessel and the cap by using a cap that is provided on its lower rim with a circumferential groove for holding a sealing ring.

In order to improve the sealing effect, in a further refinement of the method, a sealing surface, which surrounds the endangered area and acts as a contact surface for the sealing ring is incorporated on the inner surface of the vessel.

Other features which are considered as characteristic for the invention are set forth in the appended claims.

Although the invention is illustrated and described herein as embodied in a method for repairing or preventing damage to a bushing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a bushing, which has been repaired according to the invention, for the situation in which damage has occurred only on the bushing;

FIG. 2 is a diagrammatic, sectional view of one advantageous alternative in which a supporting sleeve is additionally welded to the outside of a reactor pressure vessel;

FIG. 3 is a diagrammatic, sectional view of a repaired bushing with a cover on the inside of the reactor pressure vessel, for damage, which has occurred only in the weld bead;

FIG. 4 is a diagrammatic, sectional view of the bushing in which the repair methods shown in FIGS. 1 and 3 have been combined; and

FIG. 5 is a diagrammatic, sectional view of a damaged bushing before being repaired.

### DESCRIPTION OF THE PREFERRED EMBODIMENTS

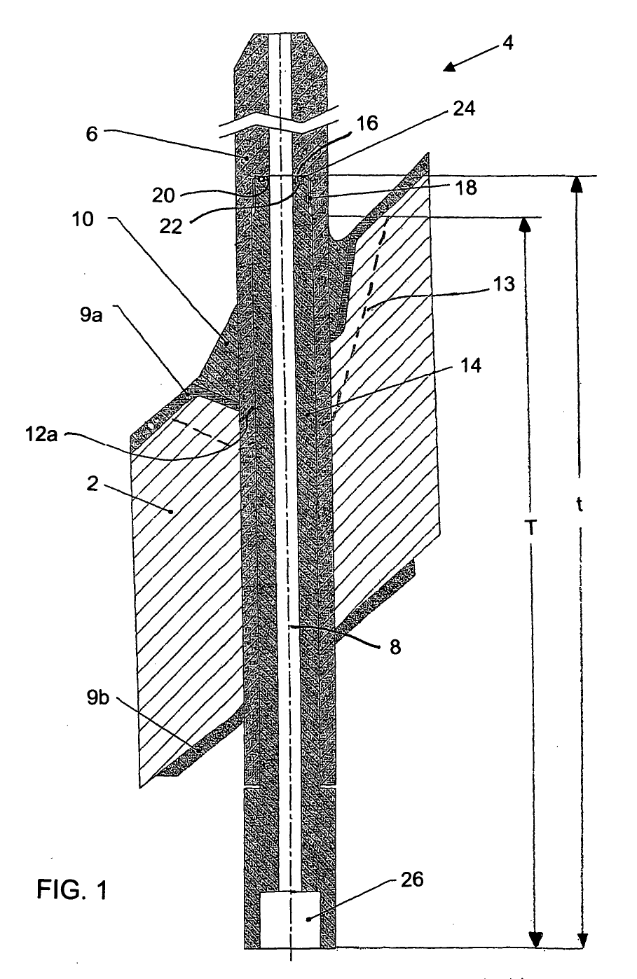

Referring now to the figures of the drawing in detail and first, particularly, to FIG. 1 thereof, there is shown an internal sleeve 14, which covers an inner surface of an endangered area 13, has been inserted into the bushing 6 from the outside. In other words, the internal sleeve 14, which has been inserted from the outside and is used as a cover extends into the bushing 6 to a depth t which is greater than a maximum depth T of the endangered area 13. In order to allow the internal sleeve 14 to be inserted with the cross-sectional area of a bushing opening 8 remaining unchanged, the bushing 6 is drilled out into the damage-free area. A planar shoulder 16, which surrounds the bushing opening 8 is milled out at the bottom of the hole and is used as a sealing surface. A thread 18 is incorporated in the bushing 6 in the drilled out area, into which the internal sleeve 14 (which is likewise provided with a thread) is screwed, so that this internal sleeve 14 is directly attached to the bushing 6 by a screw connection.

On its end surface 20, the internal sleeve 14 is provided with an annular circumferential groove 22. A sealing ring 24 is inserted into the groove 22 ensuring, when the internal sleeve 14 is screwed in, that it forms a sealed connection to the shoulder 16 in the bushing 6, so that no water can enter into the gap between the internal sleeve 14 and the bushing 6, so that it is no longer possible for stress corrosion cracking originating from the interior of the bushing 6 to propagate.

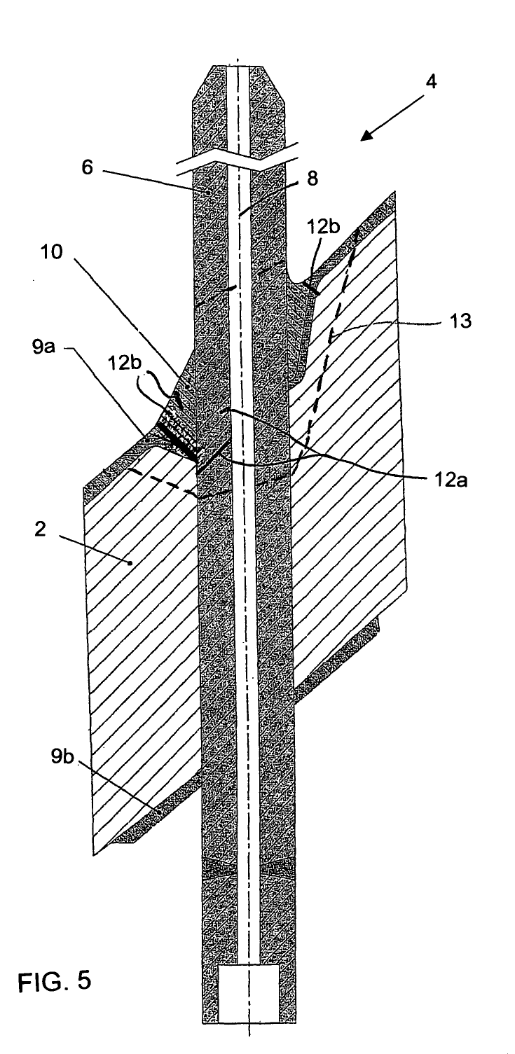

In the exemplary embodiment, the bushing 6 is also shortened, and the inserted internal sleeve 14 has a connecting part 26 which projects out of the shortened bushing 6 and is physically identical to the connecting part (FIG. 5), which was originally welded to the bushing 6. Once the internal sleeve 14 has been screwed in it is also secured against rotation.

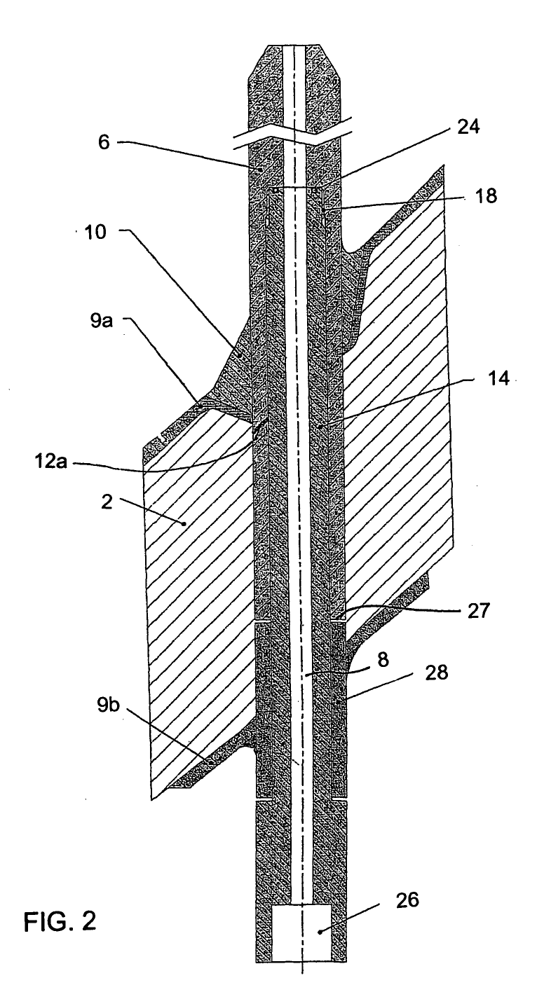

In the exemplary embodiment shown in FIG. 2, in addition to the embodiment shown in FIG. 1, the bushing 6 has also been cut off into the wall 2 of the reactor pressure vessel 4. An outer sleeve 28 is then inserted into the wall as far as the internal cut surface 27 and is welded to the wall 2 externally above the buffer weld 9b. A gap remains between the cut surface 27 and the outer sleeve 28, in order to allow different thermal expansion of the components.

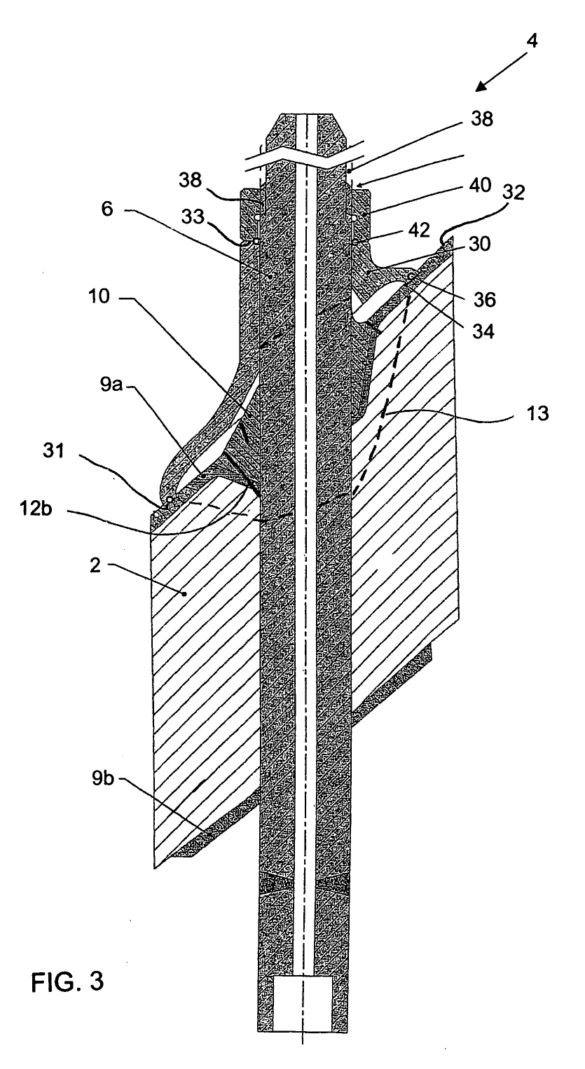

As shown in the exemplary embodiment in FIG. 3, that surface of the endangered area 13, which is located in the interior of the reactor pressure vessel 4 is covered. For this purpose a bell or cap 30 is pushed onto the bushing 6 from the inside of the reactor pressure vessel 4, until its lower rim 31 is seated on an inner surface 32 of the reactor pressure vessel 4 forming a seal, and surrounds the surface of the endangered area 13 and its weld point 10 and the buffer weld 9a. In order to ensure a good seal, a circumferential sealing surface 34 is machined into the internal surface 32 of the reactor pressure vessel 4 in a previous step (for example by erosion), corresponding to the contour of the rim of the cap 30. The sealing surface 34 is used as a contact surface for a sealing ring 36, which is inserted into a circumferential groove in order to achieve the sealing effect with the circumferential groove being provided on the lower rim 31 of the cap 30.

That part of the bushing 6 which projects into the reactor pressure vessel 4 is provided with an external thread 38, onto which a retaining nut 40 is screwed, by which the cap 30 is pressed against the inner surface 32 of the reactor pressure vessel 4.

The cap 30 is provided on its upper rim 33 with an internally circumferential holding into which a seal 42 (O ring or some other appropriate profile) is inserted. The shape of the holder, which in the example is formed by a circumferential incline on the inner edge of the rim, is in this case matched to the profile of the seal 42, an O ring in the example, in order to produce a sealed joint between the cap 30 and the outer casing of the bushing 6 when the retaining nut 40 is tightened, thus reliably preventing the ingress of water into the interior of the cap 30. In this case as well, the retaining nut 40 is secured against rotation in the final installed state.

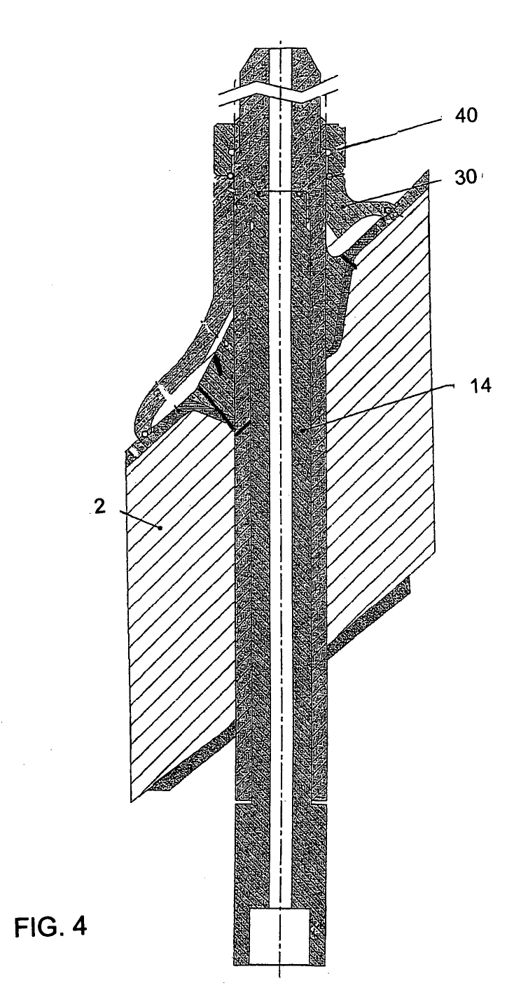

FIG. 4 illustrates a situation after a repair, in which the repair measures after FIG. 1 and FIG. 3 have been carried out jointly.

This application claims the priority, under 35 U.S.C. § 119, of German patent application No. 102 48 427.9, filed Oct. 17, 2002; the entire disclosure of the prior application is herewith incorporated by reference.

1. A method for repairing or preventing damage to a bushing, the bushing being welded into a vessel for a coolant circuit of a water-cooled nuclear reactor by an internal weld bead, the damage being caused in an endangered area by an influence of water located within the bushing or within the vessel on surfaces in contact with the water, which comprises the steps of:
protecting at least one of the surfaces against the influence of the water by a cover, the cover being mechanically connected to the bushing.

2. The method according to claim 1, which further comprises providing the cover on an inner surface of the bushing.

3. The method according to claim 2, which further comprises:
enlarging an internal cross-section area of the bushing to a depth, which is greater than a depth of the endangered area resulting in an enlarged internal area; and
inserting an internal sleeve, the internal sleeve functioning as the cover.

4. The method according to claim 3, which further comprises providing the bushing with an internal thread into which the internal sleeve is screwed.

5. The method according to claim 4, which further comprises providing the bushing, at a bottom of the enlarged internal area with a shoulder, which is circumferential on an internal circumference and on which an end surface of the internal sleeve is seated.

6. The method according to claim 5, which further comprises inserting a sealing ring between the shoulder and the end surface of the internal sleeve.

7. The method according to claim 3, which further comprises:
cutting off a part of the bushing which faces away from an internal face of the vessel; and
inserting the internal sleeve, the internal sleeve projecting beyond a remaining part of the bushing, with the projection substantially being in a same shape as the part which has been cut off.

8. The method according to claim 3, which further comprises:
cutting off a first part of the bushing which faces away from an internal face of the vessel resulting in a cutout, the first part being longer than a second part of the bushing which projects into a space outside the vessel, in such a way that a resultant cut surface is located in the wall of the vessel;
inserting an outer sleeve into the cutout; and
welding the outer sleeve on the outside to the wall of the vessel, the outer sleeve being used to guide the internal sleeve.

9. The method according to claim 1, which further comprises covering a surface of the endangered area (13) located within the vessel.

10. The method according to claim 9, which further comprises:
mounting a cap on an outer surface of the bushing; and
pushing the cap mounted on the outer surface of the bushing onto that part of the bushing which projects into the vessel, the cap having a lower rim resting on a surface of the vessel forming a seal, and the cap surrounds the endangered area.

11. The method according to claim 10, which further comprises:
providing the bushing with an external thread at a free end projecting into the vessel; and
screwing onto the external thread a retaining nut to exert a compression force on the cap.

12. The method according to claim 11, which further comprises:
providing an upper rim of the cap with an inner side having an incline for forming a depression between the bushing and the upper rim of the cap; and
inserting a sealing ring into the depression, the sealing ring being pressed both against an outer surface of the bushing and against the incline while the retaining nut exerts a compression force, preventing an ingress of water between the bushing and the cap.

13. The method according to claim 10, which further comprises:
providing the lower rim of the cap with a circumferential groove; and
inserting a sealing ring in the circumferential groove.

14. The method according to claim 13, which further comprises incorporating on an inner surface of the vessel a sealing surface surrounding the endangered area and acts as a contact surface for the sealing ring.

15. The method according to claim 1, wherein the bushing is welded into an instrumentation tube which is passed through a wall of a reactor pressure vessel of a pressurized water reactor.

16. The method according to claim 1, wherein the endangered area includes an area of the internal weld bead.
